(19) United States
(12) Patent Application Publication
(10) Pub. No.: US 2013/0090960 A1
(43) Pub. Date: Apr. 11, 2013

(54) WEB BROWSER-BASED BUSINESS ACTIVITY MONITORING

(71) Applicants: Bertrand H. Portier, Austin, TX (US); Mei Y. Selvage, Portland, ME (US); Suraj Shinde, Metepec (MX)

(72) Inventors: Bertrand H. Portier, Austin, TX (US); Mei Y. Selvage, Portland, ME (US); Suraj Shinde, Metepec (MX)

(73) Assignee: International Business Machines Corporation, Armonk, NY (US)

(21) Appl. No.: 13/270,494

(22) Filed: Oct. 11, 2011

(51) Int. Cl. G06Q 10/00

(52) U.S. Cl. 705/7.11

(57) ABSTRACT

A system including: at least one computing device adapted to monitor business activities, by performing actions including: collecting business activity data at a first web browser, the business activity data indicating at least one aspect of a business transaction conducted at a second, distinct web browser; sorting the business activity data according to one or more sorting parameters; and providing a report including the sorted business activity data at a uniform resource locator (URL) accessible to both the first web browser and the second, distinct web browser.

### FIELD OF THE INVENTION

Aspects disclosed herein relate to solutions for business activity monitoring. More specifically, aspects disclosed herein relate to solutions for a web browser-based approach to business activity monitoring.

### BACKGROUND

Business Activity Monitoring (or, BAM) refers to the aggregation, analysis, and presentation of real-time information about activities within an organization, as well as those activities involving customers and partners outside of the organization. A business activity can include a business process orchestrated by business process management (BPM) software, or a business process including a series of activities spanning multiple systems and applications. BAM is an enterprise solution capable of providing a real-time summary of business activities to operations managers and upper management in a business organization.

BAM solutions include the following core components: business process monitoring, process metrics, key performance indicators, analysis/reports and alerts. BAM architectures require server-side components (agents for monitoring or analyzing) deployed to web servers, application servers, or core systems. In this configuration the agents are deployed to the back-end servers that run the business processes. Additionally, analysis and management components reside on back-end servers.

Conventionally, an information technology (IT) group (e.g., a department of personnel and associated resources, collectively called IT herein) performs the tasks of deploying agents on back-end servers to create the BAM architecture. This can be a complex and costly process. Additionally, deploying and maintaining these agents on backend servers consumes valuable manpower resources, and is prone to error. BAM is used to serve the needs of business users (e.g., Business Executives), yet the delays and errors associated with IT group intervention can impede the success of BAM. While the goal of BPM is to enable a business to do more with less IT group involvement, the nature of the BAM architectures (distributed via Java Platform, Enterprise Edition, or JEE) makes the business dependent on an IT group.

Conventionally, BAM reports or dashboards/scorecards can be generated and subsequently accessed/viewed from web browsers. However, the role of the web browser is limited to only the client-side graphical user interface (GUI) within the BAM architecture. As such, the full potential of the web browser is not utilized. One current approach includes designing dashboards/scorecards and build reports in the browser, but keeping the monitoring agents, analysis (intelligence) engine, and report generations on the server. This applies to even those Cloud-based (virtualized) solutions, which require a server-side component (hosted in the cloud), which cannot be run stand-alone in the web browser.

### BRIEF DESCRIPTION

Aspects of the invention include a system having: at least one computing device adapted to monitor business activities, by performing actions including: collecting business activity data at a first web browser, the business activity data indicating at least one aspect of a business transaction conducted at a second, distinct web browser; sorting the business activity data according to one or more sorting parameters; and providing a report including the sorted business activity data at a uniform resource locator (URL) accessible to both the first web browser and the second, distinct web browser.

A first aspect of the invention includes a system having: at least one computing device adapted to monitor business activities, by performing actions including: collecting business activity data at a first web browser, the business activity data indicating at least one aspect of a business transaction conducted at a second, distinct web browser; sorting the business activity data according to one or more sorting parameters; and providing a report including the sorted business activity data at a uniform resource locator (URL) accessible to both the first web browser and the second, distinct web browser.

A second aspect of the invention includes a computer-implemented method of monitoring business activities, the method including: collecting business activity data at a first web browser, the business activity data indicating at least one aspect of a business transaction conducted at a second, distinct web browser; sorting the business activity data according to one or more sorting parameters; and providing a report including the sorted business activity data at a uniform resource locator (URL) accessible to both the first web browser and the second, distinct web browser.

A third aspect of the invention includes a computer program having program code embodied in at least one computer readable storage medium, which when executed, enables a computer system to implement a method for monitoring business activities, the method including: collecting business activity data at a first web browser, the business activity data indicating at least one aspect of a business transaction conducted at a second, distinct web browser; sorting the business activity data according to one or more sorting parameters; and providing a report including the sorted business activity data at a uniform resource locator (URL) accessible to both the first web browser and the second, distinct web browser.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic depiction of a browser-based business activity monitoring network according to embodiments of the invention.

FIG. 2 shows a schematic depiction of a data flow environment according to embodiments of the invention.

FIG. 3 shows a schematic depiction of an environment according to embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As noted herein, aspects disclosed relate to solutions for business activity monitoring. More specifically, aspects disclosed herein relate to solutions for a web browser-based approach to business activity monitoring.

Business Activity Monitoring (or, BAM) refers to the aggregation, analysis, and presentation of real-time information about activities within an organization, as well as those activities involving customers and partners outside of the organization. A business activity can include a business process orchestrated by business process management (BPM) software, or a business process including a series of activities spanning multiple systems and applications. BAM is an enterprise solution capable of providing a real-time summary of business activities to operations managers and upper management in a business organization.

BAM solutions include the following core components: business process monitoring, process metrics, key performance indicators, analysis/reports and alerts. BAM architectures require server-side components (agents for monitoring or analyzing) deployed to web servers, application servers, or core systems. In this configuration the agents are deployed to the back-end servers that run the business processes. Additionally, analysis and management components reside on back-end servers.

Conventionally, an information technology (IT) group (e.g., a department of personnel and associated resources, collectively called IT herein) performs the tasks of deploying agents on back-end servers to create the BAM architecture. This can be a complex and costly process. Additionally, deploying and maintaining these agents on backend servers consumes valuable manpower resources, and is prone to error. BAM is used to serve the needs of business users (e.g., business managers, executives or the like), yet the delays and errors associated with IT group intervention can impede the success of BAM. While the goal of BPM is to enable a business to do more with less IT group involvement, the nature of the BAM architectures (distributed via Java Platform, Enterprise Edition, or JEE) makes the business dependent on an IT group.

Conventionally, BAM reports or dashboards/scorecards can be generated and subsequently accessed/viewed from web browsers. However, the role of the web browser is limited to only the client-side graphical user interface (GUI) within the BAM architecture. As such, the full potential of the web browser is not utilized. One current approach includes designing dashboards/scorecards and build reports in the browser, but keeping the monitoring agents, analysis (intelligence) engine, and report generations on the server. This applies to even those Cloud-based (virtualized) solutions, which require a server-side component (hosted in the cloud), which cannot be run stand-alone in the web browser. Additionally, existing BAM solutions rely upon predetermined models of business processes in their monitoring approaches, which can prevent monitoring of new or unfamiliar business processes.

In contrast to these conventional approaches, aspects include monitoring a user's interaction with a web browser to discover (and monitor) business processes without the need for predetermined models/modeling. Aspects allow for monitoring the execution of business activities, as the user conducts those activities through their web browsers. Example business activities can include: a customer placing an order on the Web, a Customer Sales Representative (CSR) placing an order for a customer, a customer applying for a loan, a supplier fulfilling an inventory request, a social services employee entering data about their cases, a bank employee opening a new account for a new customer, etc.

As noted herein, aspects of the invention include solely web-browser based solutions for BAM. This configuration can utilize a plurality of interconnected web browsers to enhance the capabilities of each individual web browser, thereby eliminating the need for back-end (server-side) systems to perform BAM. This differs from the conventional approaches to BAM, which all require back-end systems. That is, these conventional approaches, even in the “Cloud” computing configurations, all require server-side hardware to execute one or more BAM functions. Additionally, these conventional server-side approaches require IT support for maintenance and updating of hardware and software. In contrast, aspects described herein can rely solely on a group of web browsers to monitor business activities. In some cases, aspects include monitoring these business activities (e.g., using a managing web browser) and building one or more reports (or, dashboards) on the business activities at the managing web browser. That managing web browser can additionally host the report in some embodiments, and can make the report available to other browsers (e.g., a customer, intermediate party, etc.) via the uniform resource locator (URL) of the managing web browser. Additionally, it is understood that the report can be accessible to any web browser with access to the URL of the managing web browser.

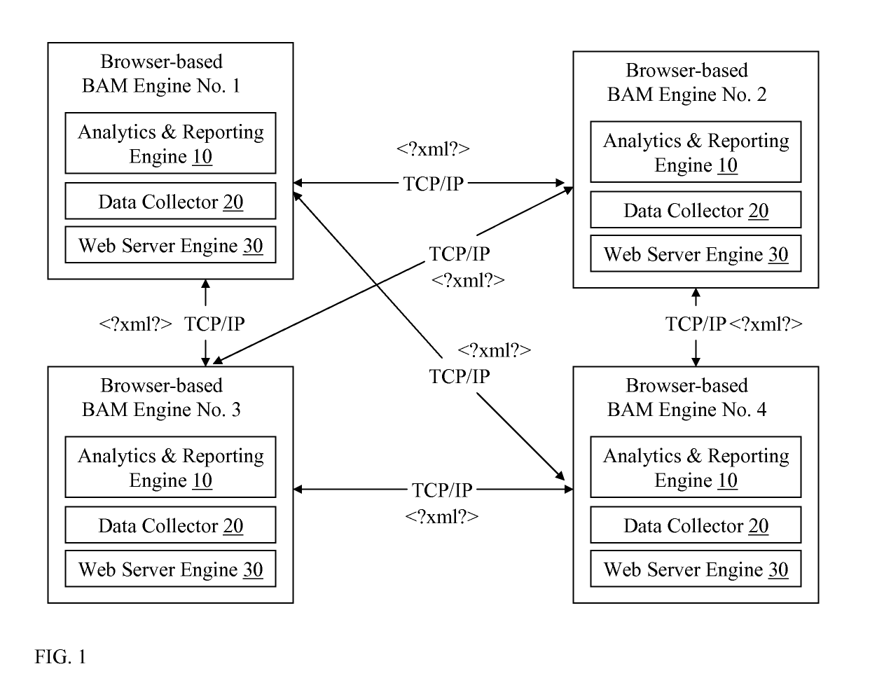

Turning to FIG. 1, a schematic depiction of a network of linked browser-based business activity monitoring (BAM) engines (nos. 1, 2, 3, 4), or simply, BAM engines, is shown according to embodiments. In some respects, this group of browser-based engines can act as “lightweight” servers, without physical server components. That is, through their interconnection, the group of browser-based engines can collectively handle tasks traditionally performed at a server. As shown, each browser-based BAM engine (1, 2, 3, 4) can include an analytics and reporting engine 10, a data collector 20 and a web server (e.g., a Windows, Apache, MySQL, PHP/Perl/Python, or WAMP, or a hypertext pre-processor such as a PHP) engine 30. The data collector 20 can be configured to monitor the client action at the browser, such as when a particular task/transaction begins and ends, and other activities associated with that transaction. This data collector 20 can send that client action data to another BAM engine (e.g., no. 2) for further processing of the client action. Simultaneously, or at a distinct time, the analytics and reporting engine 10 can compile the client action data, and provide the compiled client action data to another browser-based BAM engine (e.g., no. 3) for compilation, display and/or output, such as in a report or dashboard. This browser-based BAM engine no. 3 could provide the report or dashboard to a monitor or other interface for viewing by a user such as a consumer, or a monitoring entity. In some cases, this monitor or interface could be a mobile phone, tablet computer, laptop, desktop, etc. In some cases, this browser-based BAM engine no. 3 could host the report at its uniform resource locator (URL) address, or provide the report at another URL address accessible by one or more of the other browser-based BAM engines (e.g., nos. 1, 2 or 4). In some cases, a plurality of browser-based BAM engines can be utilized to perform the functions described herein. For example, in some cases, one or more intermediary browser-based BAM engines can be utilized to process client action data.

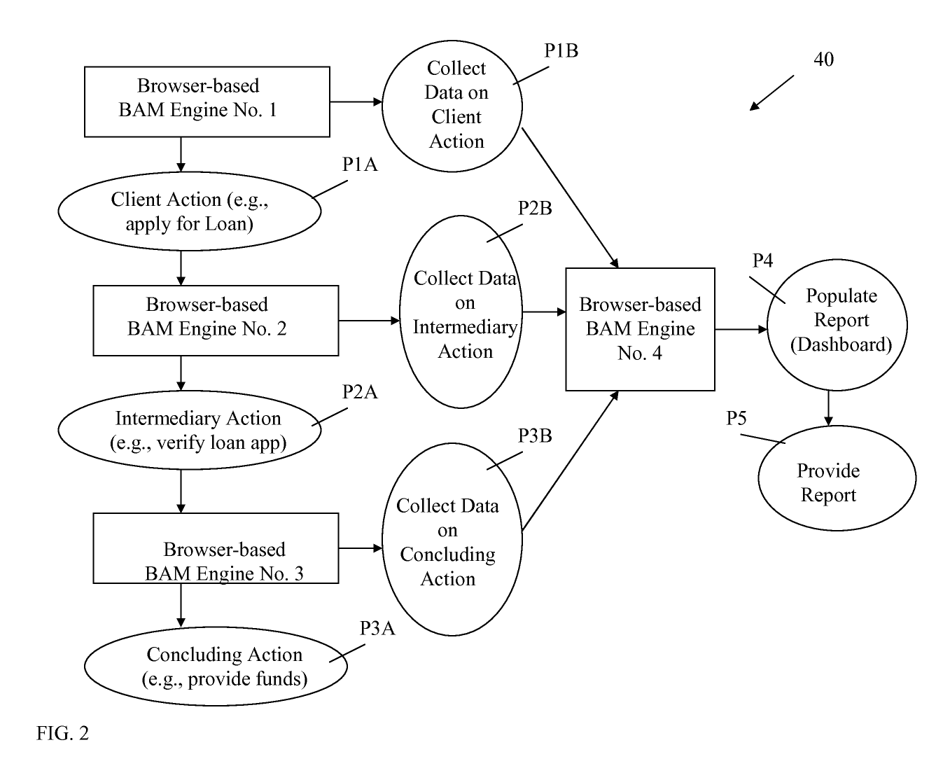

FIG. 2 shows a schematic data flow diagram 40 illustrating an example configuration of browser-based BAM engines, according to embodiments of the invention. This flow diagram 40 demonstrates an example configuration where an intermediary (or second) browser-based BAM engine no. 2 interacts with a first browser-based BAM engine no. 1 (e.g., a client), and a third browser-based BAM engine no.3 (e.g., a service or product provider) to complete a transaction. As shown, this configuration further includes a fourth browser-based BAM engine no. 4 for collecting data on actions at each of the first three BAM engines (nos. 1, 2 and 3).

In a first process P1A, a client can use browser-based BAM engine no. 1 to perform a client action (e.g., begin a transaction, apply for a loan, purchase an item, etc.). The action can include initiating a request to an intermediary browser-based BAM engine no. 2. At process P2A, an intermediate party can use the browser-based BAM engine no. 2 to perform some intermediary action (e.g., verify a credit card, verify a loan, etc.) with respect to the initial client action, and transmit data relating to that intermediary action (e.g., verification data) to a third (or, concluding) browser-based BAM engine no. 3. After process P2A, in process P3A, the browser-based BAM engine no. 3 can then perform some action (e.g., a concluding or final action) to either finalize the transaction using the verification data, or provide additional data to yet another browser-based BAM engine (not shown).

Substantially simultaneous with the processes P1A, P2A and P3A, respectively, processes P1B, P2B, and P3B can be executed by a browser-based BAM engine no. 4, where each of processes P1B, P2B, and P3B includes collecting data about the actions described in processes P1A, P2A and P3A, respectively. The browser-based BAM engine no. 4 can collect data about each of the actions performed by browser-based BAM engine nos. 1, 2 and 3, and use that data to populate a report in process P4. The data about each of the actions can include a time that a user began an action (e.g., logged into a web portal, opened a web page, etc.), a duration of the action (e.g., a duration logged in, or a duration from opening the web page until execution of the transaction), an end time of the action, a history of pages visited during, before or after the action, a user (e.g., customer) name and/or address, employee number or location (e.g., a bank branch location), etc. Process P5 can include providing the report (or, dashboard) available for viewing by one or more of the browser-based BAM engines (e.g., nos., 1, 2, and/or 4) or other browser-based BAM engine(s) not shown.

An example business activity capable of being monitored according to aspects of the invention is an application for a loan. In this example, a consumer (human user) can apply for a loan using his/her browser-based BAM engine (e.g., no. 1). The consumer may initiate this business activity using a mobile phone, a tablet, a netbook, a laptop, a desktop, or any other suitable web-capable mobile device. In this example, the user can apply for a loan by completing a loan application form using browser-based BAM engine no. 1, implemented in his/her device (e.g., a tablet computer). The user can access this loan application through a web page or portal, and begin filling in the application form. The user may have navigated to the loan application page from a previously-visited web page, where the user was directed away from that page via an advertisement, link, or incentive. BAM engine no. 1, in some cases, can track the user's actions prior to arriving at the loan application page, and can also track the user's actions after leaving the loan application page. BAM engine no. 1 can also track the length of time, keystrokes, entries, and other pertinent data related to the user's interaction with the loan application page. The BAM engine no. 1 can submit the information relating to activities at BAM engine no. 1 (before, during and after the loan application process) to BAM engine no. 4, which can begin to compile business activity data. After the user completes the loan application, BAM engine no. 1 can then submit the loan application to BAM engine no. 2, which can be utilized, e.g., by a loan verification company to verify the details of the loan application. BAM engine no. 2 can be implemented at any suitable web-based device described herein and/or known in the art, and in some cases, is utilized by an employee at the loan verification company. This employee can process the loan application according to conventional approaches via a web browser. The processing can include, for example, verifying income statements, debt statements, personal information, etc. of the applicant (user), which may include querying external browser-based BAM engines (not shown).

The actions included in the processing of the loan application at browser-based BAM engine no. 2 can be tracked by that BAM engine and sent to browser-based BAM engine no. 4 for compilation, reporting, posting, etc. After verifying the loan application, BAM engine no. 2 can transmit a verification to BAM engine no. 3, which may include a bank or other financial institution capable of fulfilling the loan. In this example, BAM engine no. 3 can be operated by a bank officer or other user/employee at the bank, and may allow that bank officer to disperse funds to the original user (loan applicant). Handling of the verification and dispersal of the funds by BAM engine no. 3 can include a number of conventional actions, all of which can be executed using BAM engine no. 3. Additionally, as with BAM engine nos. 1 and 2, BAM engine no. 3 is configured to provide data about its action (e.g., dispersal of funds) to BAM engine no. 4 for compilation, reporting, posting, etc. In some embodiments, BAM engine no. 4 can be operated by a user/manager of a BAM infrastructure. That is, BAM engine no. 4 can be operated by a manager, executive, or other party interested in monitoring the business activities transacted at BAM engine nos. 1, 2 and/or 3.

One of the aspects of the invention that differentiates from prior approaches is the process of gathering data about business activities locally at each browser-based BAM engine (e.g., BAM engine nos. 1, 2, 3, 4, etc.). This allows each browser-based BAM engine to provide data about its activities to other BAM engines, including a managing BAM engine (e.g., browser-based BAM engine no. 4, FIG. 2). The managing BAM engine can obtain this data about the activities of other BAM engines, and process the data according to one or more sorting (e.g., data compilation/analysis) parameters. In some cases, the sorting parameters can include algorithms used to correlate the business activity data, e.g., sorting based upon a type of business transaction such as a customer loan, or a product purchase. For example, the managing BAM engine can recognize that the actions from BAM engine nos. 1 and 2 are related to the same transaction (e.g., a customer loan). After correlating this data from BAM engine nos. 1 and 2, the managing BAM engine can aggregate the related data and build required graphics. For example, if a dashboard is required to display the average time it takes to process loans by loan type, the managing BAM engine will sort the loan data according to loan type, and compute the average processing time. The managing BAM engine can then build the user interface(s) (e.g., pie chart, bar chart, speedometer) for displaying the data via one or more graphics.

Unlike conventional approaches, the managing BAM engine can compile data from the other BAM engines without necessarily having knowledge of the business process(es) implemented at those other BAM engines. That is, the managing BAM engine does not have to call the other BAM engines for particular known data types as in the conventional approaches, as each BAM engine has its own data collector 20 and analytics and reporting engine 10. This allows the system to perform BAM functions on business processes that do not follow some prescribed formula/process. Continuing with the loan example used herein, the system would not necessarily have to know that a loan application process entails application, verification and disbursement in order to gather data about an applied-for loan. Conventional systems rely on back-end servers for data collection, and these back-end servers must call devices in the business activity network for particular types of data (e.g., data about a loan application, data about a loan verification process, etc.) in order to process that data. This makes those conventional systems inept to monitor business processes which do not follow a prescribed (predetermined) sequence of events.

It is understood that this browser-based BAM approach (using engines) can be implemented by a plurality of distinct devices, which may include one or more of mobile phones, laptops, tablets, netbooks, etc. Each BAM engine described herein can be deployed on one or more web-enabled devices connected over a network, e.g., a wireless network, WAN, LAN, etc.

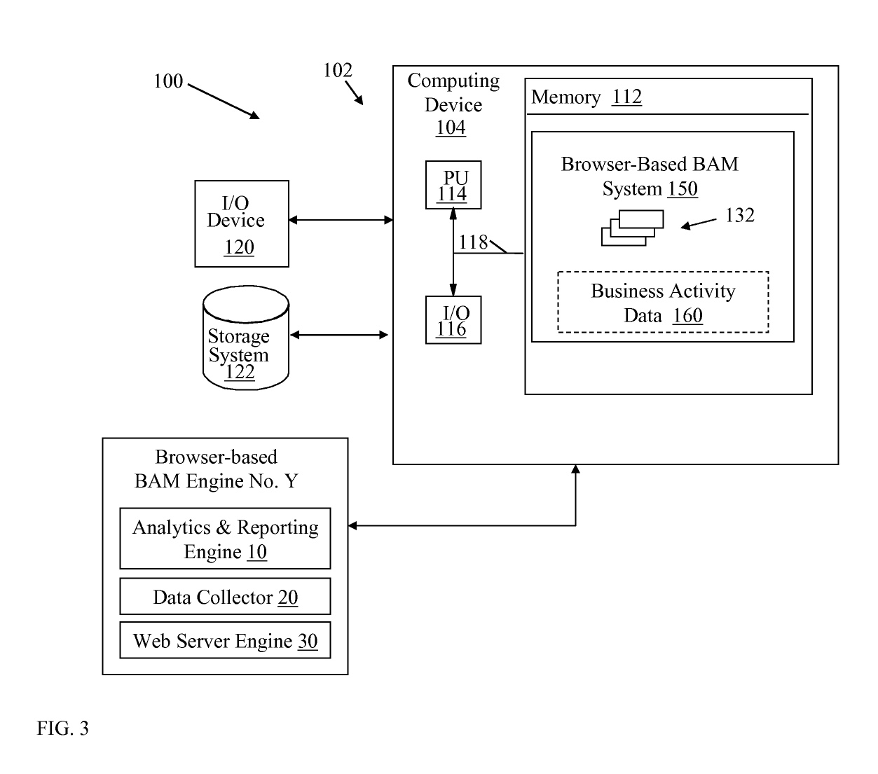

FIG. 3 depicts an illustrative environment 101 for web browser-based business activity monitoring (BAM) according to embodiments. To this extent, the environment 101 includes a computer system 102 that can perform a process described herein in order to monitor business activities using a browser-based approach. In particular, the computer system 102 is shown as including a browser-based BAM system 150, which makes computer system 102 operable to monitor business activities using a browser-based approach by performing any/all of the processes described herein and implementing any/all of the embodiments described herein.

The computer system 102 is shown including a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the browser-based BAM system 150, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable a human user 112 to interact with the computer system 102 and/or one or more communications devices to enable a system user 112 to communicate with the computer system 102 using any type of communications link. To this extent, the Browser-based BAM system 150 can manage a set of interfaces (e.g., graphical user interface(s), application program interface, etc.) that enable human and/or system users 112 to interact with the Browser-based BAM system 150. Further, the Browser-based BAM system 150 can manage (e.g., store, retrieve, create, manipulate, organize, present, etc.) data, such as design data (including mask-level data, task data, prioritization data, etc.) using any solution.

In any event, the computer system 102 can comprise one or more general purpose computing articles of manufacture (e.g., computing devices) capable of executing program code, such as the Browser-based BAM system 150, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the Browser-based BAM system 150 can be embodied as any combination of system software and/or application software.

Further, the Browser-based BAM system 150 can be implemented using a set of modules 132. In this case, a module 132 can enable the computer system 102 to perform a set of tasks used by the Browser-based BAM system 150, and can be separately developed and/or implemented apart from other portions of the Browser-based BAM system 150. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of Browser-based BAM system 150 fixed thereon (e.g., one or more modules 132). However, it is understood that the computer system 102 and Browser-based BAM system 150 are only representative of various possible equivalent computer systems that may perform a process described herein. To this extent, in other embodiments, the functionality provided by the computer system 102 and Browser-based BAM system 150 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 102 can obtain or provide data, such as business activity data 160 using any solution. The computer system 102 can generate and/or be used to business activity data 160, from one or more data stores, receive business activity data 160, from another system, send business activity data 160 to another system, etc. As noted herein, this business activity data 160 can include data about business transactions from one or more browser-based BAM engines (shown as a generic browser-based BAM engine X). This business activity data 160 can be collected at the data collector 20 of each of the browser-based BAM engines, and transmitted to one or more of the other BAM engines/systems in any conventional manner.

While shown and described herein as a method and system for prioritizing processes in the manufacture of integrated circuits, it is understood that aspects of the invention further provide various alternative embodiments. For example, in one embodiment, the invention provides a computer program fixed in at least one computer-readable medium, which when executed, enables a computer system to prioritize processes in the manufacture of integrated circuits. To this extent, the computer-readable medium includes program code, such as the browser-based BAM system 150 (FIG. 3), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the browser-based BAM system 150 (FIG. 3), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for prioritizing processes in forming an integrated circuit. In this case, a computer system, such as the computer system 102 (FIG. 3), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
at least one computing device adapted to monitor business activities including a loan application process, by performing actions comprising:
collecting business activity data at a first web browser, the business activity data indicating at least one aspect of a business transaction conducted at a second, distinct web browser,
wherein the business transaction includes an application for a loan, and
wherein the second web browser is initiated by a human user applying for the loan on a web-enabled device;
collecting additional business activity data at the first web browser, the additional business activity data indicating at least one aspect of the loan application conducted at a third web browser distinct from the first web browser and the second web browser,
wherein the third web browser is initiated by a loan verification company to verify the application for the loan at a distinct web-enabled device,
wherein each distinct one of the first web browser, the second web browser and the third web browser include:
an analytics and reporting engine;
a data collector; and
a web server engine,
wherein the data collector for each distinct one of the first web browser, the second web browser and the third web browser collects the business activity data locally at each distinct one of the first web browser, the second web browser and the third web browser;
sorting the business activity data about the application for the loan according to one or more sorting parameters at the first web browser; and
providing a report including the sorted business activity data at a uniform resource locator (URL) accessible to the first web browser, the second, distinct web browser, and the third, distinct web browser.

2. The system of claim 1, wherein the URL is hosted by the first web browser.

3. The system of claim 1, wherein the sorting parameter is based upon a type of the business transaction.

4-6. (canceled)

7. A computer-implemented method of monitoring business activities including a loan application process, performed using at least one computing device, the method comprising:
collecting business activity data at a first web browser, the business activity data indicating at least one aspect of a business transaction conducted at a second, distinct web browser, using the at least one computing device,
wherein the business transaction includes an application for a loan, and
wherein the second web browser is initiated by a human user applying for the loan on a web-enabled device;
collecting additional business activity data at the first web browser, the additional business activity data indicating at least one aspect of the loan application conducted at a third web browser distinct from the first web browser and the second web browser,
wherein the third web browser is initiated by a loan verification company to verify the application for the loan at a distinct web-enabled device,
wherein each distinct one of the first web browser, the second web browser and the third web browser include:
an analytics and reporting engine;
a data collector; and
a web server engine,
wherein the data collector for each distinct one of the first web browser, the second web browser and the third web browser collects the business activity data locally at each distinct one of the first web browser, the second web browser and the third web browser;
sorting the business activity data about the application for the loan according to one or more sorting parameters at the first web browser, using the at least one computing device; and
providing a report including the sorted business activity data at a uniform resource locator (URL) accessible to the first web browser, the second, distinct web browser, and the third, distinct web browser.

8. The method of claim 7, wherein the URL is hosted by the first web browser.

9. The method of claim 7, wherein the sorting parameter is based upon a type of the business transaction.

10-12. (canceled)

13. A computer program comprising program code embodied in at least one computer readable storage medium, which when executed, enables a computer system to implement a method for monitoring business activities including a loan application process, the method comprising:
collecting business activity data at a first web browser, the business activity data indicating at least one aspect of a business transaction conducted at a second, distinct web browser,
wherein the business transaction includes an application for a loan, and
wherein the second web browser is initiated by a human user applying for the loan on a web-enabled device;
collecting additional business activity data at the first web browser, the additional business activity data indicating at least one aspect of the loan application conducted at a third web browser distinct from the first web browser and the second web browser,
wherein the third web browser is initiated by a loan verification company to verify the application for the loan at a distinct web-enabled device,
wherein each distinct one of the first web browser, the second web browser and the third web browser include:
an analytics and reporting engine;
a data collector; and
a web server engine,
wherein the data collector for each distinct one of the first web browser, the second web browser and the third web browser collects the business activity data locally at each distinct one of the first web browser, the second web browser and the third web browser;
sorting the business activity data about the application for the loan according to one or more sorting parameters at the first web browser; and
providing a report including the sorted business activity data at a uniform resource locator (URL) accessible to the first web browser, the second, distinct web browser, and the third, distinct web browser.

14. The program product of claim 13, wherein the URL is hosted by the first web browser.

15. The program product of claim 13, wherein the sorting parameter is based upon a type of the business transaction.

16-20. (canceled)
